(19) United States
(12) Patent Application Publication
(10) Pub. No.: US 2025/0305360 A1
(43) Pub. Date: Oct. 2, 2025

(54) TREADS FOR CLIMBING PRODUCTS AND METHODS OF MANUFACTURE

(71) Applicant: Werner Co., Greenville, PA (US)

(72) Inventors: John MAHER, Crystal Lakes, IL (US); David S. POZGAY, Wilmette, IL (US); Weston VAN WAMBEKE, Severna Park, MD (US)

(21) Appl. No.: 18/854,870

(22) PCT Filed: Apr. 11, 2023
(86) PCT No.: PCT/US2023/018186

§ 371 Date: Oct. 7, 2024

Related U.S. Application Data
(60) Provisional application No. 63/329,881, filed on Apr. 11, 2022.

(51) Int. Cl. E06C 7/08; B21C 23/10; B21C 35/02; B23P 9/02

(52) U.S. Cl. CPC E06C 7/081; B21C 23/10; B21C 35/026; B23P 9/02

(57) ABSTRACT

Tread members for climbing products are described herein that have indented treads that may provide enhanced grip and/or improved slip resistance. The treads are formed on a standing or other engagement surface of the tread member. In some approaches, the treads may be incorporated into an upper surface of a rung, step, platform, or plank of the climbing product. The treads include a plurality of pips or ridges extending across the tread member in a first direction. The first direction may be an extrusion direction or a lateral direction. The pips or ridges may provide slip resistance in a direction perpendicular to the first direction. The pips or ridges further have a plurality of indentations or cuts formed therein at an angle of about 5 degrees up to about 90 degrees relative to the first direction. So oriented, the indentations may provide slip resistance in additional directions.

### CROSS-REFERENCE TO RELATED APPLICATION(S)

This application claims the benefit of U.S. Provisional Application No. 63/329,881 filed Apr. 11, 2022, which is incorporated herein by reference in its entirety.

### TECHNICAL FIELD

This invention relates generally to climbing products and, more particularly, to treads for climbing products.

### BACKGROUND

Climbing products, such as ladders, work platforms, and scaffolds, generally include one or more standing surfaces or other engagement surfaces that provide an interface between the user and the climbing product where a user's foot or hand engages the product. These surfaces may take a variety of forms such as rungs, steps, platforms, or planks. Such standing or engagement surfaces may include a tread to provide traction, for example, for a user standing on the surface.

### BRIEF DESCRIPTION OF THE DRAWINGS

Disclosed herein are embodiments of systems, apparatuses, and methods relating to treads for a surface of a climbing product.

FIG. 1 is a perspective view of an extension ladder, in accordance with some embodiments;

FIG. 2 is an enlarged view of a rung of the encircled area D of FIG. 1;

FIG. 3 is an enlarged view of the encircled area E in FIG. 2;

FIG. 4 is a top plan view of the rung of FIG. 2;

FIG. 5 is a right side elevation view of the rung of FIG. 4;

FIG. 6 is a partial view of the rung of FIG. 4 taken along line F-F;

FIG. 7 is an enlarged view of the encircled area G in FIG. 6;

FIG. 8 is a perspective view of a platform or podium ladder, in accordance with some embodiments;

FIG. 9 is a perspective view of a platform of the platform ladder of FIG. 8;

FIG. 10 is an enlarged view of the encircled area H of FIG. 9;

FIG. 11A is a perspective view of an alternative platform for the platform or podium ladder of FIG. 8 having a different pattern of indentations;

FIG. 11B is an enlarged view of the encircled area I of FIG. 11A;

FIG. 12 is a perspective view of a portion of a plank having an exemplary tread pattern;

FIG. 13 is a top plan view of the portion of the plank in FIG. 12;

FIG. 14 is a perspective view of a work platform, in accordance with some embodiments;

FIG. 15 is a perspective view of a step ladder, in accordance with some embodiments;

FIG. 16 is an enlarged perspective view of a step of the step ladder of FIG. 15;

FIG. 17 is a top plan view of the step of FIG. 16;

FIG. 18 is a right side elevation view of the step of FIG. 17;

FIG. 19 is a partial view of the step of FIG. 17 taken along line B-B;

FIG. 20 is an enlarged cross-sectional view of the encircled area C in FIG. 19;

FIG. 21 is a perspective view of a step having an alternative tread pattern;

FIG. 22 is a flow diagram of a method of making a metal extrusion having a slip-resistant tread;

FIG. 23 is a perspective view of a knurling wheel, in accordance with some embodiments;

FIG. 24 is a perspective view of another knurling wheel, in accordance with some embodiments;

FIG. 25 is a front elevation view of a pair of knurling wheels, in accordance with some embodiments;

FIG. 26 is a schematic diagram of an alternative cross-section for an indentation of the treads described herein;

FIG. 27 is a schematic diagram of another alternative cross-section for an indentation of the treads described herein;

FIG. 28 is an image of an exemplary knurling wheel, in accordance with some embodiments; and

FIG. 29 is an image of an exemplary knurler, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, tread members or sections for climbing products are described herein that have treads that may provide enhanced grip and/or improved slip resistance. The treads are formed on a standing or other engagement surface of the tread member. For example, the treads may be incorporated into an upper surface of a rung, step, platform, or plank of the climbing product. The treads include a plurality of pips or ridges extending across the tread member in a first direction. The first direction may be an extrusion direction or a lateral direction. The pips or ridges may provide slip resistance in a direction perpendicular to the first direction (e.g. in a direction perpendicular to the pips or ridges). The pips or ridges further have a plurality of indentations or cuts formed therein at an angle of about 5 degrees up to about 90 degrees relative to the first direction. So oriented, the indentations may provide slip resistance in additional directions, including in a direction perpendicular to the indentations. For example, when the indentations are oriented 90 degrees relative to the first direction (e.g., the extrusion direction), the indentations may provide slip resistance in a direction parallel to the first direction. In addition, the pips and indentations together may provide enhanced slip resistance in a rotational direction as well. Thus, the indentations add one or more additional directions of slip resistance to improve grip for a user of the climbing product that interfaces with the tread and/or for an object placed on the tread. In some aspects, a climbing product in accordance with these teachings includes a first rail and a second rail in parallel and spaced relation with the first rail. The climbing further includes a metal extrusion coupled to the first rail and the second rail. The metal extrusion includes a surface having a plurality of pips extending in an extrusion direction of the metal extrusion. The plurality of pips have a first plurality of indentations formed therein. The first plurality of indentations are disposed at an angle of between about 5 degrees and about 85 degrees relative to the extrusion direction.

In some aspects, a tread member for a climbing product includes a surface having a tread. The tread comprises a plurality of pips extending in first direction of the surface. A first plurality of indentations are formed in the plurality of pips at a first angle of about 5 degrees up to about 85 degrees relative to the first direction.

In some aspects, the tread member may be a metal extrusion and, in some aspects, the first direction is an extrusion direction.

In some aspects, the tread further comprises a second plurality of indentations formed perpendicular to the first direction or at an second angle relative to the first direction, the second angle being between about 5 degrees and about 85 degrees relative to the first direction.

In yet other aspects, a method of making a metal extrusion having a slip-resistant tread includes extruding a metal in an extrusion direction to form a metal extrusion having at least one planar surface. The metal extrusion includes a plurality of pips that extend along the at least one planar surface in the extrusion direction and protrude upward from the at least one planar surface. The method further includes forming a plurality of indentations in the plurality of pips, the plurality of indentations disposed at an angle of about 5 degrees up to about 85 degrees relative to the extrusion direction.

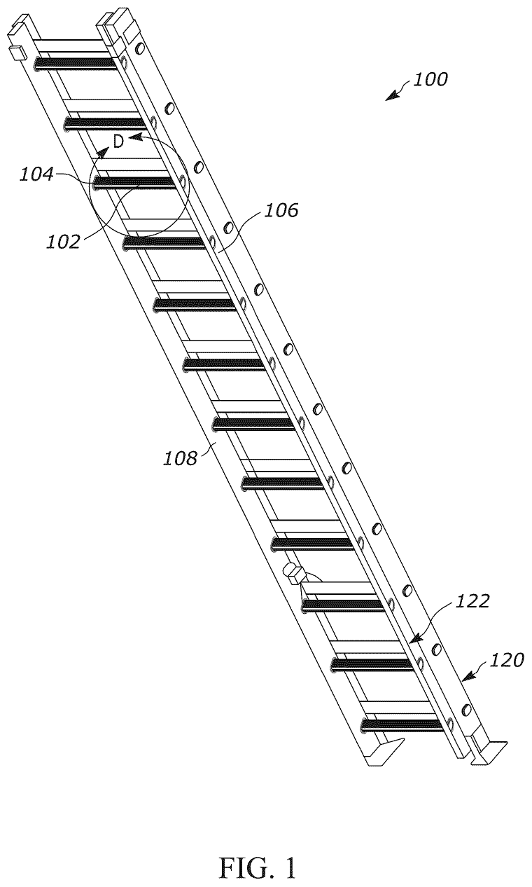

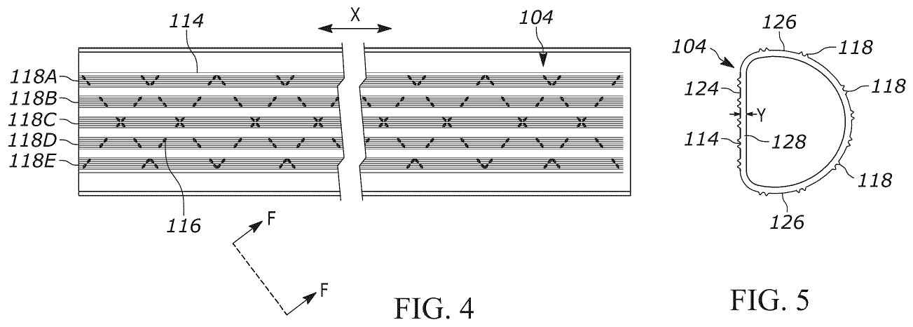

Referring now to the drawings and, in particular, to FIGS. 1-7, a first embodiment of a ladder having a slip-resistant tread is shown. FIG. 1 illustrates an extension ladder 100 including a rung 102 having a slip-resistant tread 104. The slip-resistant tread 104 includes a pattern formed by a plurality of indentations 116 in the rung 102. In particular, the indentations 116 are formed in pips 114 that are present on a planar upper surface 124 of the rung 102. The slip-resistant tread 104 includes both the pips 114 and the indentations 116 in such pips 114. The indentations 116 may enhance grip to improve traction and enhance grip with the rung 102 in one or more directions including both linear and rotational directions. FIGS. 1-3 illustrate the extension ladder 100 and the rung 102. FIGS. 4-7 illustrate in further detail the pattern and topography of the slip-resistant tread 104.

In one illustrative embodiment shown in FIG. 1, the extension ladder 100 includes a base section 120 and a fly section 122. The base section 120 is slidably coupled to the fly section 122. As illustrated, the base section 120 is the lower of the two adjacent sections, from which the fly section 122 extends upward. The fly section 122 includes a first rail 106 parallel to and spaced apart from a second rail 18. The rung 102 is disposed between the first rail 106 and the second rail 108. The rung 102 is generally “D”-shaped.

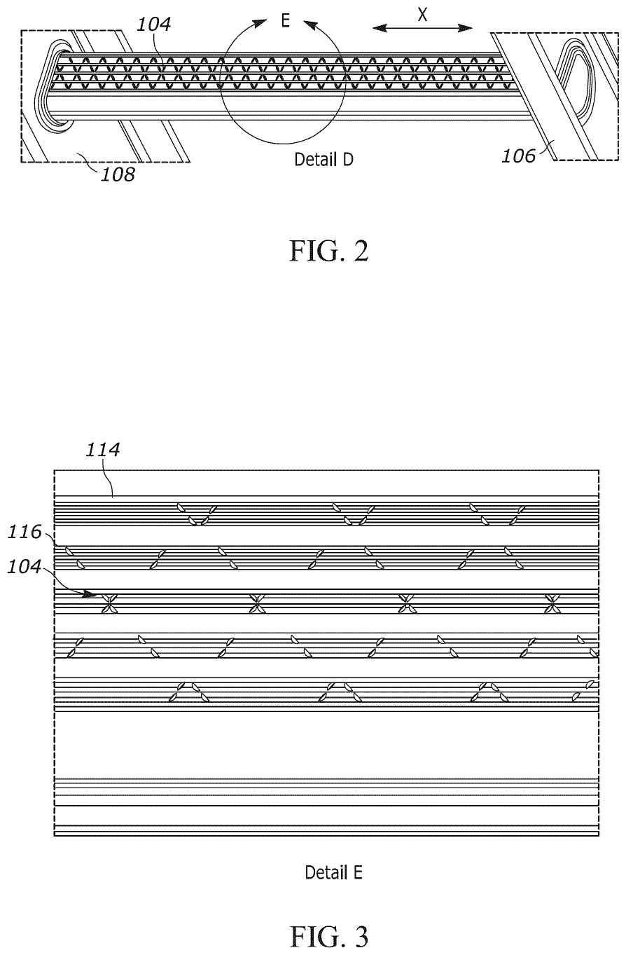

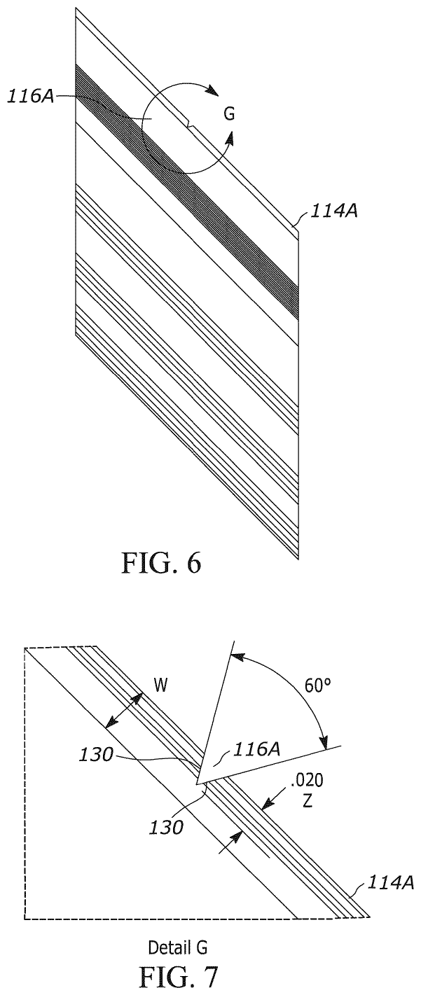

The rung 102 may be formed as a metal extrusion via an extrusion process. It is also contemplated that the rung 102 may be die cast. Reference line “X” shows a lateral direction across the rung 102 and, in some aspects, an extrusion direction for the rung 102 in FIG. 2. In some aspects, the rung 102 is formed from steel, magnesium, magnesium alloys, aluminum, or aluminum alloys. The rung 102 includes a plurality of pips 114 disposed on an external surface thereof. As used herein a “pip” refers to a protrusion that extends laterally across at least a portion of a rung (e.g., in the extrusion direction of the rung) and that extends upward from a plane forming the body of the rung. FIGS. 4 and 5 illustrate the pips on the rung 102 in greater detail. It is contemplated that the ridges 464 may provide slip resistance and/or enhanced grip in a direction perpendicular to the extrusion direction X.

The top surface of the rung 102 includes the slip-resistant tread 104. It is contemplated that the slip-resistant tread 104 may be incorporated into any standing or gripping surface on the extension ladder 100 or other surfaces that may engage with a user's foot, hand, or other point of contact. The slip-resistant tread 104 includes pips 114 that are present on the upper surface of the rung 102 and the indentations 116 formed in such pips 114. In other configurations, such as those where the user engagement surface is disposed on a lower surface thereof, such as, e.g., those surfaces which may be grasped by a user's hand, the slip-resistant pattern also may be disposed on a lower surface of the element such as a rung.

In some aspects, each rung of the extension ladder 100 may incorporate the slip-resistant tread 104. In other aspects, a number of rungs present at locations along the ladder where a user is likely to pause or stand for an extended period of time may incorporate the slip-resistant tread 104. In yet other aspects, only the rungs of the base section 120 and/or the fly section 122 may incorporate the slip-resistant tread 104. In one example, the fly section 122 may include the slip-resistant tread 104 to provide enhanced grip, as the fly section 122 of the extension ladder 100 may be positioned higher than the base section 120 during use. In another example, the slip-resistant tread 104 may only be included on rungs up to the approved highest standing level for the extension ladder 100.

In a similar matter, the slip-resistant tread 104 may be disposed along the entire length of the rung in some configurations, though in other configurations may only be disposed in particular areas of the rung such as a more central area. By way of example, the increase slip-resistance patter may be disposed primarily in the center of the rung where a user is more likely to stand but may not be disposed in or may have a decreased number of indentations an area of the rung or climbing product where the user is only likely to be grasping. In short, the density of the indentations along the length of the rung or may be generally uniform along the length of the rung. The indentations also may be uniform or vary along a width of the rung as well.

As shown in FIG. 4, the slip-resistant tread 104 pattern on the planar upper surface of the rung 102 is formed by both the pips 114 and the indentations 116. The pips 114 may be formed in one or more discrete groups 118. The rung 102 includes a first group 118A, a second group 118B, a third group 118C, a fourth group 118D, and a fifth group 118E of pips 114. Though, any number of groups 118 of pips 114 may be disposed on the planar upper surface 124 of the rung 102. The groups 118 of pips 114 on the rung 102 each include two pips. However, any number of pips 114 may be included in a group 118. In some approaches, the group 118 of pips 114 may include between about 1 and about 30 pips, between about 2 and about 15 pips, between about 2 and about 10 pips, and, in some aspects, between about 2 and about 9 pips. In other approaches, the pips may not be formed in distinct groups 118 and, instead, the pips 114 may be evenly spaced across a width of the rung 102 (e.g., a width of the rung 102 being the dimension across the rung 102 in a direction perpendicular to the extrusion direction X). In yet other approaches, the pips may be randomly spaced across the width of the rung 102.

The pips 114 include the indentations 116, which form a pattern. In the rung 102, the indentations 116 form a cross-hatching pattern across a length of the rung 102 (e.g., the length of the rung 102 extending across the rung in the extrusion direction X). In some approaches, the indentations 116 may be formed in other patterns such as chevrons, letters (e.g., “W”s or “X”s), words, diagonal lines, curved lines, concentric circles or ovals, etc. The indentations 116 may form a symmetric or asymmetric pattern with respect to the extrusion direction X. In yet other approaches, the indentations 116 may form words and/or numbers, such as a brand name, a model number, a duty rating, a load capacity (e.g., 375 lb), a certification e.g., ANSI), etc.

One or more of the indentations 116 may be disposed at an angle relative to the extrusion direction X of the rung 102. For example, the indentations 116 may be disposed at angles based on the positions a user is likely to assume while standing on the rung 102 and/or based on how a user's foot is commonly oriented on the rung 102, for example, in order to provide improved grip for common use scenarios. For example, the indentations 116 may be positioned such that they are approximately perpendicular to a direction in which a user generally stands while on the rung 102.

In some approaches, one or more of the indentations 116 may be disposed at an angle of between about 5 degrees and about 90 degrees, between about 5 and about 85 degrees, between about 5 and about 45 degrees, between about 10 degrees and about 80 degrees, between about 10 degrees and about 40 degrees, between about 20 degrees and about 40 degrees, between about 20 degrees and about 70 degrees, between about 25 and about 65 degrees, between about 30 degrees and about 60 degrees, between about 40 degrees and about 80 degrees, between about 30 degrees and about 50 degrees, between about 45 and about 85 degrees, between about 50 and about 80 degrees, between about 60 degrees and about 80 degrees, or in some aspects, between about 40 degrees and about 60 degrees relative to an extrusion direction X of the rung 102.

In some approaches, the indentations 116 may be disposed at a number of different orientations or different angles relative to the extrusion direction X of the rung 102. In this manner, the indentations may provide improved slip resistance in multiple directions so that a user may move randomly about the rung 102 with enhanced grip. For example, there may be a number of groups of indentations including, for example, a first group of indentations at a first angle relative to the extrusion direction X and a second group of indentations at a second angle relative to the extrusion direction X.

The pips 114 and/or the indentations 116 may extend along an entire length of the rung 102 or, in some approaches, may only extend across one or more portions of the length of the rung 102. In some approaches, the pips 114 and/or the plurality of indentations 115 may be disposed on portions of the rung 102 where a user is likely to stand on the rung 102 or otherwise have a point of contact with the rung 102. In one example, the pips 114 extend along the length of the rung 102 and the indentations 116 are formed in a first section and a second section corresponding with areas where a user is likely to position a left foot and right foot on the rung 102.

Additionally, while the indentations 116 in FIG. 4 are oriented at the same or similar angles with respect to the extrusion direction (e.g., at approximately 45-degree angles), it is to be understood that the indentations may be oriented at different angles. For example, there may be a first plurality of indentations oriented at a first angle (e.g., 45 degrees) relative to the extrusion direction X and a second plurality of indentations oriented at a second angle (e.g., 90 degrees) relative to the extrusion direction, etc.

As shown in FIG. 5, a cross-section of the rung 102 is generally “D”-shaped. The rung 102 has a flat or planar upper surface 124 with angular side surfaces 126 depending therefrom. Though, in some aspects, the rung 102 may have other suitable geometries having a substantially flat upper surface for the slip-resistant tread 104, for example, a generally inverted triangular cross-section, a rectangular cross-section, circular cross-section, or a square cross-section.

In the embodiment depicted in FIG. 5, the groups 118 of pips 114 are present both on the planar upper surface 124 of the rung 102 and on the angular side surfaces 126 of the rung 102. In some approaches, the groups 118 of pips 114 may only be present on the planar upper surface 124 of the rung 102.

In some configurations, the pips 114 may have a generally triangular cross-section. The pips 114 may take any suitable shape and, in some aspects, the pips 114 may be pointed, and for example have a pointed apex, to further enhance grip with the rung 102 and/or provide slip-resistance. Though, the pips 114 may have other suitable cross-sectional shapes. For example, the pips may have a generally square or rectangular cross-section. The pip may be shaped such that it has more than one peak or apex, for example, an upper surface of the pip may be a concave valley bounded on either side by two peaks.

As shown in FIGS. 6 and 7, a particular indentation 116A in the indentations 116 is illustrated in greater detail. The indentation 116A is formed in a particular pip 114A of the pips 114. One or more of the indentations 116 in the slip-resistant tread 104 may be configured as shown in FIG. 7.

By one approach, the indentation 116A may be generally “V”-shaped, having sidewalls 130 that are sloped. The angle between the sidewalls may be between about 10 degrees and about 170 degrees, about 90 to about 150 degrees, about 90 to about 130 degrees, about 10 degrees and about 90 degrees, between about 40 degrees and about 80 degrees, and, in some aspects, between about 50 degrees and about 70 degrees. In other approaches, the indentation 116A may have a flattened or rounded-out bottom and, accordingly, may be generally “U”-shaped. A flattened or rounded-out bottom of the indentation 116A may help to provide an additional engagement surface for a shoe or other objection coming into contact with the slip-resistant tread 104 of the rung 102.

In some approaches, the indentations may have a depth Z of between about 0.001 inches and about 0.1 inches, between about 0.01 and about 0.08 inches, and, in some aspects, between about 0.02 inches and about 0.05 inches. Further, in some approaches, the indentations may extend into the entire thickness of the pip 214.

In certain approaches, a ratio of the depth X of the indentation 116 to the thickness W of the pip 114 may be between about 0.2 and about 0.8, between about 0.3 and about 0.7, between about 0.4 and about 0.6, between about 0.2 and about 0.5, or between about 0.4 and about 0.8.

[symbol]

The indentations 116 extend into the pips 114 and do not extend into the body 128 of the rung 102. In this manner, the maximum height of the indentation is typically the height of the pip. It is contemplated that forming the indentations 116 only in the pips 114 enables the indentations 116 to provide enhanced grip and/or slip resistance without impeding or minimally impeding with the structural integrity or strength of the rung 102.

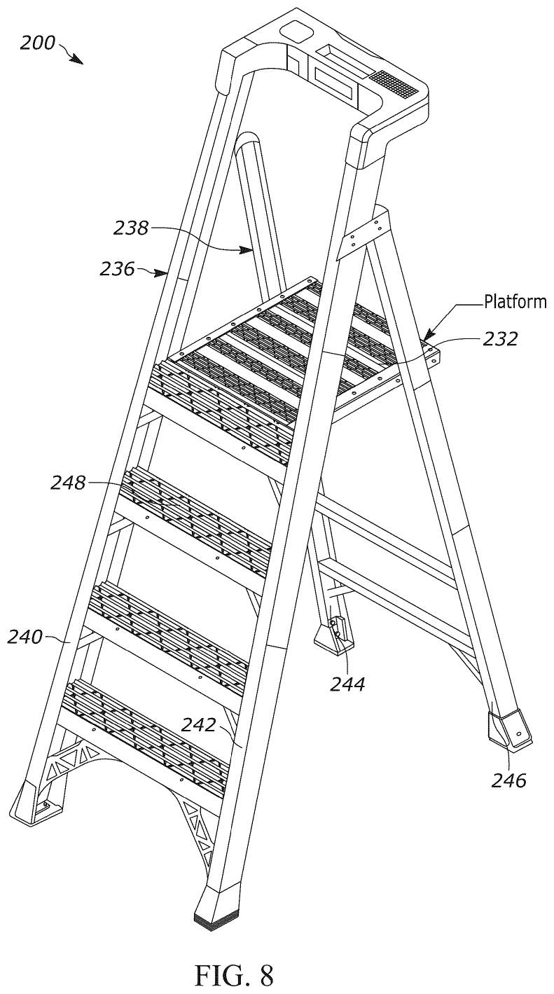

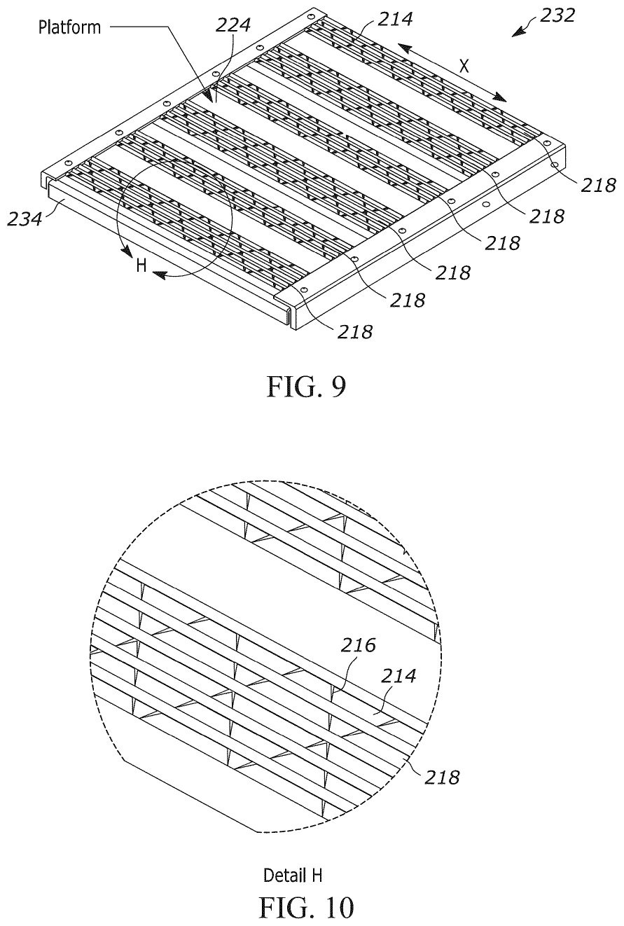

Turning now to FIGS. 8-10, a second embodiment of a climbing product having a slip-resistant tread is shown. FIG. 8 illustrates a platform or podium ladder 200 including a platform 232 having a slip-resistant tread 204. Elements in the second embodiment that are similar to those in the first embodiment have been given similar reference numbers in the two-hundred series and only the general differences will be discussed below. For example, the slip-resistant tread 104 described in the first embodiment is numbered as slip-resistant tread 204 in the second embodiment.

Like the slip-resistant tread 104 in the first embodiment, the slip-resistant tread 204 includes a pattern formed, at least in part, by a plurality of indentations 216. The plurality of indentations 216 are formed in the platform 232 and, in particular, in the pips 214 are disposed on the platform 232. The slip-resistant tread 204 includes both pips 214 that are present on the planar upper surface 224 of the platform 232 and the plurality of indentations 216 in such pips 214. The plurality of indentations 206 may enhance grip to improve traction and enhance grip with the platform 232 in one or more directions.

The platform ladder 200 includes a front section 236 and a rear section 238. The front section 236 may pivot relative to the rear section 238 of the platform ladder 200 to expand and/or collapse the platform ladder 200. The front section 236 includes a first rail 240 parallel and spaced from a second rail 242. The rear section 238 includes a third rail 244 parallel and spaced from a fourth rail 246. One or more steps 248 are disposed between the first rail 240 and the second rail 242. Further, the platform 232 is coupled to the first rail 240, the second rail 242 the third rail 244, and the fourth rail 246. A front portion of the platform 232 is disposed between the first rail 240 and the second rail 242. A rear portion of the platform 232 is disposed between the third rail 244 and the fourth rail 246.

The platform 232 includes the planar upper surface 224 with skirts 234 depending therefrom. The skirts 234 are oriented generally perpendicular to the planar upper surface 224. The planar upper surface 224 of the platform 232 includes the plurality of pips 214. The pips 214 are disposed laterally across the platform 232 in the extrusion direction X. The plurality of indentations 216 are formed in the pips 214. The pips 214 include six groups 218 of pips 214. Though, any number of groups 218 of pips 214 may be disposed on the planar upper surface 224 of the platform 232. The groups 218 of pips 214 form, at least in part, the slip-resistant tread 204. The plurality of indentations 216 form a cross-hatching (or repeating “X”) pattern across the groups 218 of pips 214.

[symbol]

One or more of the steps 248 may also include slip-resistant tread including a plurality of pips having a plurality of indentations formed therein. The pattern formed by the plurality of indentations on the steps 248 may be a cross-hatching pattern, a diagonal pattern, a chevron pattern, or any other pattern described herein. In some configurations, the slip-resistant tread on the steps 248 may be similar to that depicted in the first embodiment, the third embodiment, and/or the fourth embodiment described herein.

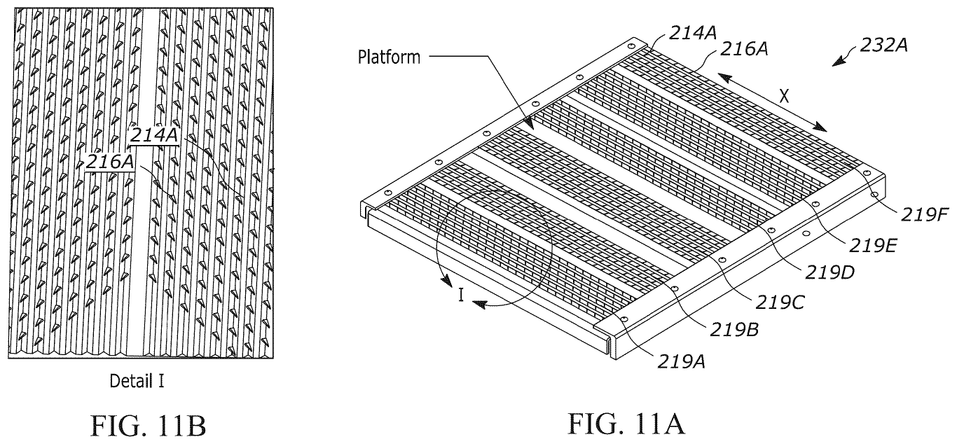

FIGS. 11A and 11B illustrate a platform 232A having an alternative pattern of indentations 216A. Similar to the platform 232, the platform 232A includes pips 214A extending along the extrusion direction of the platform 232A. The indentations 216A are disposed in the pips 214 in multiple chevron formations. The pips 214A are arranged in groups and, in particular, in a first group 219A, a second group 219B, a third group 219C, a fourth group 219D, a fifth group 219E, and a sixth group 219F. The first group 219A and the second group 219B of indentations 216A are arranged in first chevron formation. The third group 219C and the fourth group 219D of indentations 216A are formed arranged in a second chevron formation. The second chevron formation is arranged in a direction opposite the first chevron formation. The fifth group 219E and the sixth group 219F of indentations 216A are arranged in a third chevron formation. The third chevron formation is arranged in the same direction as the first chevron formation and in the opposite direction as the second chevron formation.

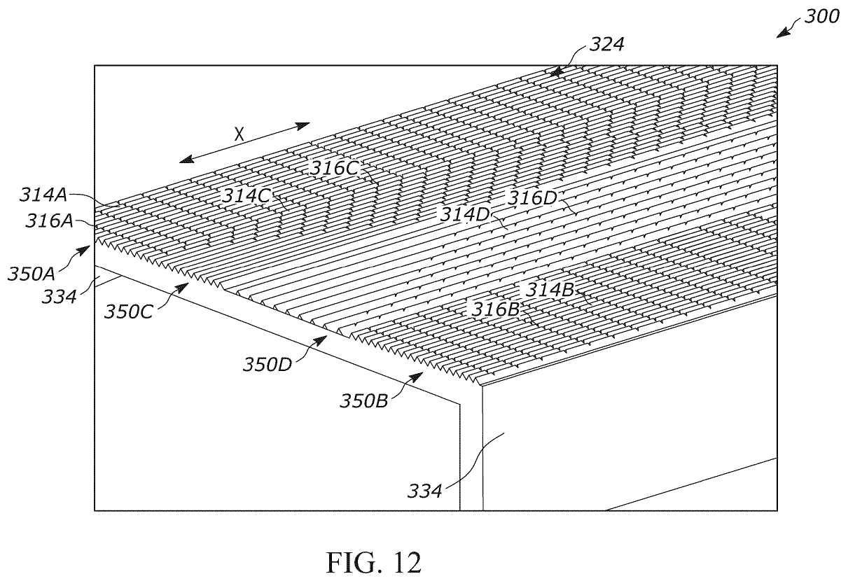

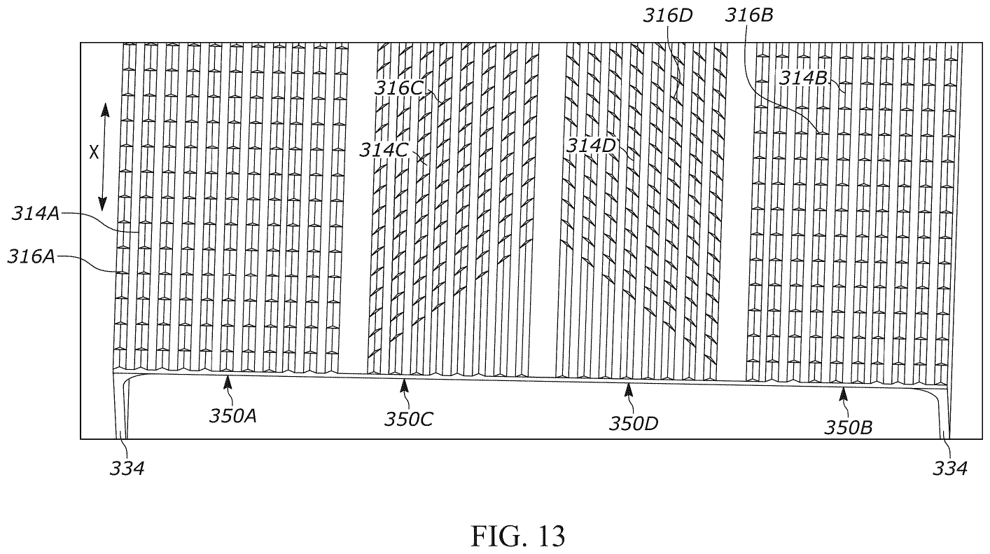

Turning to FIGS. 12 and 13, a third embodiment of a climbing product having a slip-resistant tread is shown. FIGS. 12 and 13 illustrate a plank 300 including a slip-resistant tread 304. The plank 300 may be incorporated into a scaffold, a work platform, or other climbing product. Elements in the third embodiment that are similar to those in the first embodiment have been given similar reference numbers in the three-hundred series and only the general differences will be discussed below. For example, the slip-resistant tread 104 described in the first embodiment is numbered as slip-resistant tread 304 in the second embodiment.

Like the slip-resistant tread 104 in the first embodiment, the slip-resistant tread 304 includes a pattern formed, at least in part, by a plurality of indentations 316. The plurality of indentations 316 are formed in the plank 300 and, in particular, in the pips 314 disposed on the plank 300. The slip-resistant tread 304 includes both pips 314 that are present on the planar upper surface 224 of the plank 300 and the plurality of indentations 316 in such pips 314. The plurality of indentations 306 may enhance grip to improve traction and enhance grip with the plank 300 in one or more directions.

The plank 300 includes the planar upper surface 324 with skirts 334 depending therefrom. The skirts 334 are oriented generally perpendicular to the planar upper surface 324. The plurality of indentations 316 are formed on the planar upper surface 324 of the plank 300. In some approaches, the plurality of indentations 316 may be formed only on the planar upper surface 324 and not on the skirts 334.

The planar upper surface 324 of the plank 300 includes a first outer section 350A and a second outer section 350B. The first outer section 350A includes a first plurality of pips 314A having a first plurality of indentations 316A formed therein. The second outer section 350B includes a second plurality of pips 314B having a second plurality of indentations 316B formed therein. The first plurality of indentations 316A and the second plurality of indentations 316B are formed approximately perpendicular to the extrusion direction X (e.g., along a lateral direction) of the plank 300.

The planar upper surface 324 also includes a first inner section 350C and a second inner section 350D. The first inner section 350C includes a third plurality of pips 314C having a third plurality of indentations 316C formed therein. The second inner section 350D includes a fourth plurality of pips 314D having a fourth plurality of indentations 316D formed therein. The third plurality of indentations 316C and the fourth plurality of indentations 316D are formed at an angle relative to the extrusion direction X. In some aspects, the third plurality of indentations 316C and the fourth plurality of indentations 316D are formed at an angle of about 5 degrees up to about 90 degrees, 10 degrees and about 80 degrees, between about 20 degrees and about 70 degrees, between about 30 degrees and about 60 degrees, between about 40 degrees and about 80 degrees, or in some aspects, between about 40 degrees and about 60 degrees relative to the extrusion direction X. The third plurality of indentations 316C is angled in an opposite direction as the fourth plurality of indentations 316D. Thus, the third plurality of indentations 316C and the fourth plurality of indentations 316D form a chevron pattern.

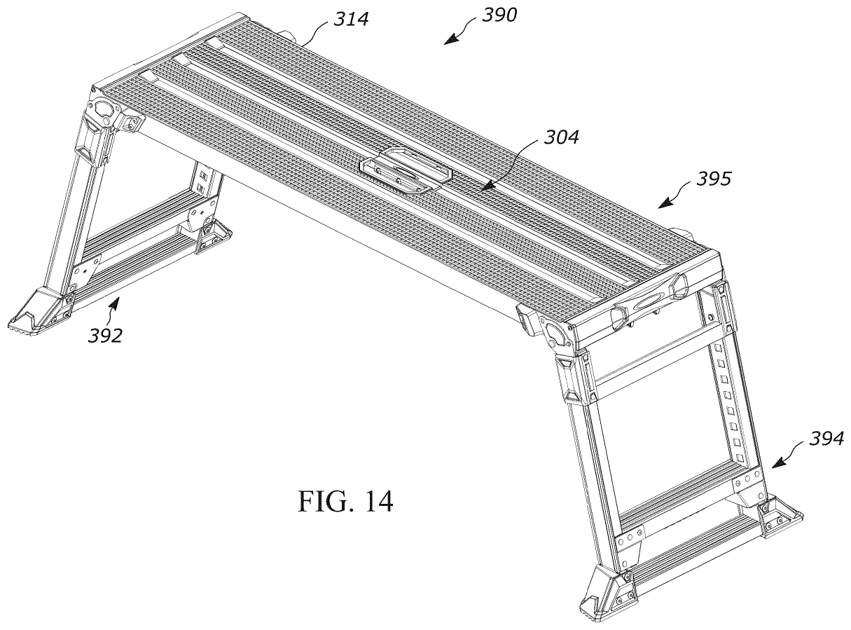

FIG. 14 illustrates a work platform 390 including the slip-resistant tread 304. The work platform 390 includes a first pair of legs 392 and a second pair of legs 394 and a plank 395. The plank 395 may be the plank illustrated and described with reference to FIGS. 12 and 13. The slip-resistant tread 304 is the same as the slip-resistant tread 304 described in the third embodiment. Though, it is to be understood that any of the slip-resistant treads described herein may be incorporated on the upper surface of the plank 395 or portions thereof.

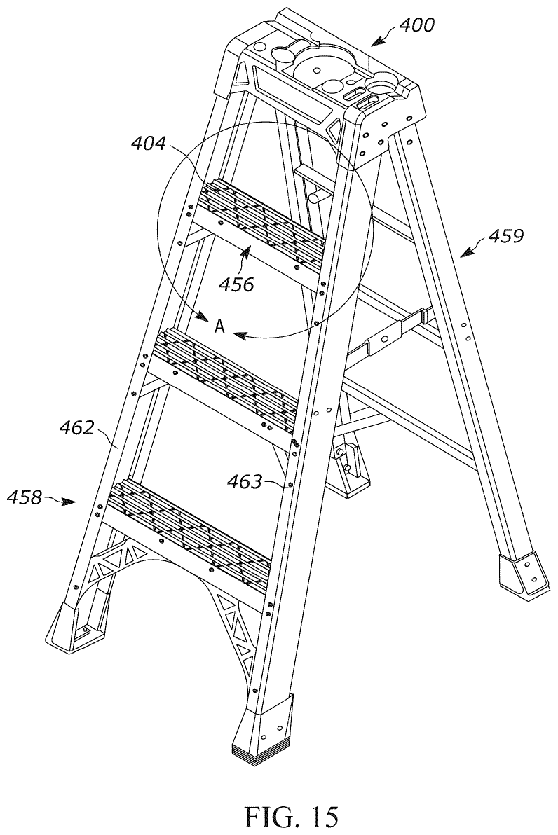

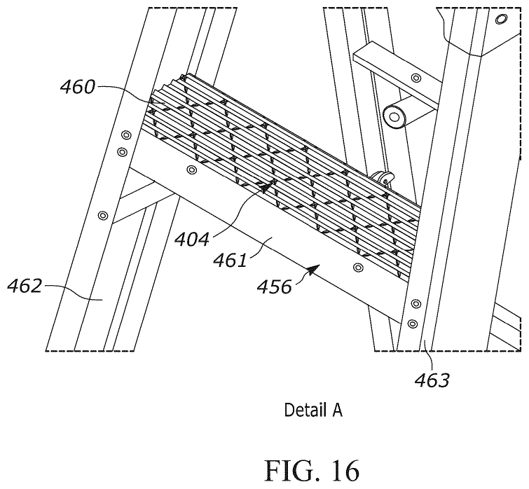

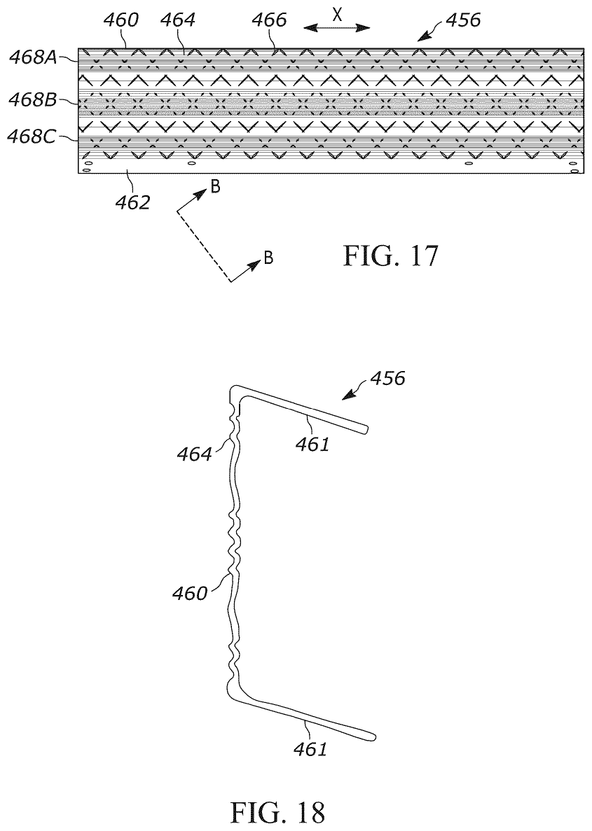

Referring now to FIGS. 15-20, a fourth embodiment of a climbing product having a slip-resistant tread is shown. FIG. 15 illustrates a step ladder 400 including a rung or step 456 having a slip-resistant tread 404. Elements in the fourth embodiment that are similar to those in the first embodiment have been given similar reference numbers in the four-hundred series and only the general differences will be discussed below. For example, the slip-resistant tread 104 described in the first embodiment is numbered as slip-resistant tread 404 in the fourth embodiment. FIGS. 15 and 16 illustrate the step ladder 400 and the step 456. FIGS. 17-20 illustrate in further detail the pattern and topography of the slip-resistant tread 404.

The step ladder 400 includes a front section 458 and a rear section 459. The step ladder 400 may include any suitable hinge assembly to rotate and/or lock the front section 458 relative to the rear section 459 to expand and/or collapse the step ladder 400. The front section includes a first rail 462 spaced from and parallel to a second rail 463. A plurality of steps disposed between the first rail 462 and the second rail 463, including the step 456.

The step 456 has an upper surface 460 and skirts 461 depending therefrom. The step 456 may be formed as a metal extrusion via an extrusion process. Reference line “X” shows a lateral direction across the step 456 and, in some aspects, an extrusion direction for the step 456. In some aspects, the step 456 is formed from steel, magnesium, magnesium alloys, aluminum, or aluminum alloys.

As shown in FIGS. 16 and 17, the upper surface 460 of the step 456 includes a plurality of ridges 464. The ridges 464 extend laterally along the length of the step 456 in an extrusion direction X of the step 456. It is contemplated that the ridges 464 may provide slip resistance and/or enhanced grip in a direction perpendicular to the extrusion direction X.

The ridges 464 are formed in groups. In particular, the upper surface 460 of the step 456 includes a first group 468A, a second group 468B, and a third group 468C of ridges. Though, the upper surface 460 may include any number of groups of ridges. Any suitable number of ridges may be included in a grouping. In some approaches, a group of ridges may include between about 1 and about 30 ridges, between about 2 and about 15 ridges, between about 2 and about 10 ridges, and, in some aspects, between about 2 and about 6 ridges. In other approaches, the ridges may not be formed in distinct groups and, instead, the ridges 464 may be evenly spaced across a width of the step 456 (e.g., a width of the step 456 being the dimension across the step 456 in a direction perpendicular to the extrusion direction X). In yet other approaches, the ridges may be randomly spaced across the width of the step 456.

The ridges 464 may generally form “V”-shaped in cross-section and include an apex. The ridges 464 may take any suitable shape. In some aspects, the ridges 464 may be pointed, and for example have a pointed apex, to further enhance grip with the step 456 and/or provide slip-resistance. In some approaches, the ridges may be generally rectangular or square in cross-section, having a generally flat upper surface.

The upper surface 460 of the step 456 includes the slip-resistant tread 404. Unlike the slip-resistant tread 104 in the first embodiment, the slip-resistant tread 404 is formed by the ridges 464 in the body of the step 456 and a plurality of indentations 466 formed in the ridges 464. The ridges 464 are distinct, for example, from the pips 114 of the first embodiment in that the ridges 464 are formed as peaks or bends in the base material of the step 456 whereas the pips 114 are formed as protrusions extending upward from the base material of the step 456. The ridges 464 include the indentations 466 formed therein. The ridges 464 and the indentations 466 form the slip-resistant tread 404.

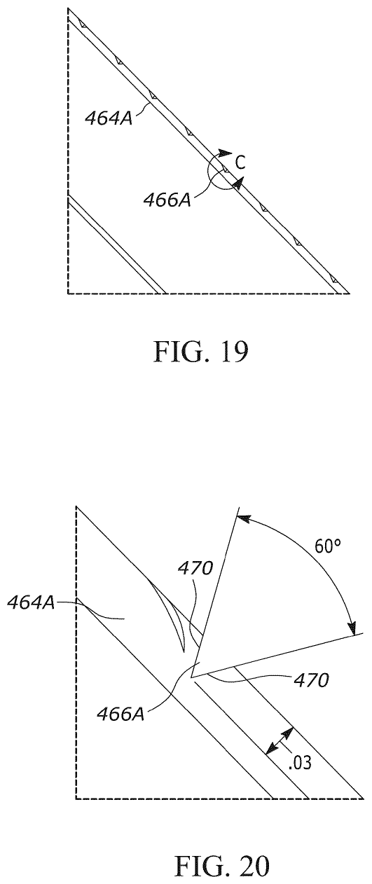

As shown in FIGS. 19 and 20, a particular indentation 466A in the indentations 466 is illustrated in greater detail. The indentation 466A is formed in a particular ridge 464A of the plurality of ridges 464. One or more of the indentations 466 in the slip-resistant tread 404 may be configured as shown in FIGS. 19 and 20.

The indentation 466A may be generally “V”-shaped, having sidewalls 470 that are sloped. The angle between the sidewalls may be between about 30 degrees and about 90 degrees, between about 40 degrees and about 80 degrees, and, in some aspects, between about 50 degrees and about 70 degrees. In other approaches, the indentation 116A may have a flattened or rounded-out bottom and, accordingly, may be generally “U”-shaped or “C”-shaped A flattened or rounded-out bottom of the indentation 466A may help to provide an additional engagement surface for a shoe or other object coming into contact with the slip-resistant tread 404 of the step 456.

In some approaches, the indentations 466 may have a depth Z of between about 0.001 inches and about 0.1 inches, between about 0.01 and about 0.08 inches, and, in some aspects, between about 0.02 inches and about 0.05 inches. Further, in some approaches, the indentations 466 may extend into about half of the wall thickness of the ridge 464. In some approaches, a wall thickness that is equal to or greater than the depth Z of the indentation 466 may extend below the indentation 466.

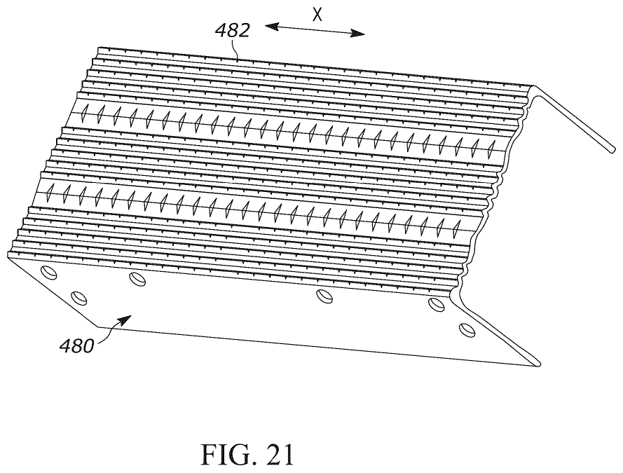

FIG. 21 illustrates an alternative pattern for the step depicted in FIGS. 13-19. The configuration and features of the step 480 is the same as that of the step 456 with the difference being that the indentations 482 in the step 480 do not form a cross-hatching pattern and, instead, form lines or rows extending along the width of the step 456. The indentations 482 are formed in a direction perpendicular or at an angle of about 90 degrees relative to the extrusion direction X. So oriented, the indentations 482 provide slip resistance in a direction parallel to the extrusion direction X. Any suitable extrusion device may be used to form the metal extrusion.

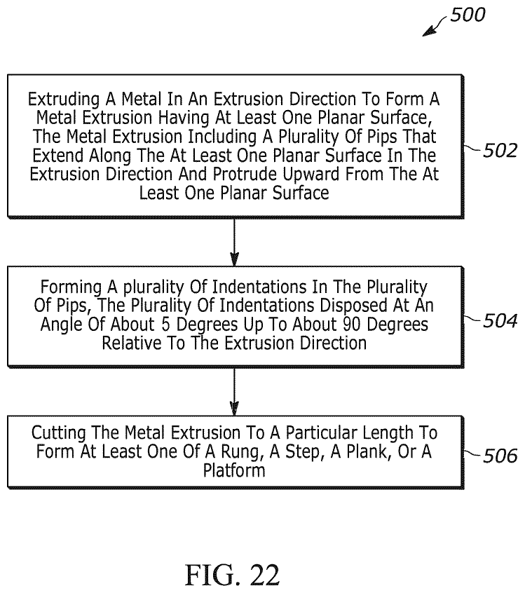

FIG. 22 illustrates a method 600 of making a metal extrusion having a slip-resistant tread, such as any one of the slip-resistant treads described herein.

The method 600 includes extruding 602 a metal in an extrusion direction to form a metal extrusion. The metal extrusion may be a component of a climbing product The metal extrusion has at least one planar surface that includes a plurality of pips. The plurality of pips that extend along the planar surface in the extrusion direction and protrude upward from the planar surface. Any suitable extrusion equipment may be used to form the metal extrusion. It is contemplated that pips and or ridges may be formed as part of the metal extrusion during the extrusion process.

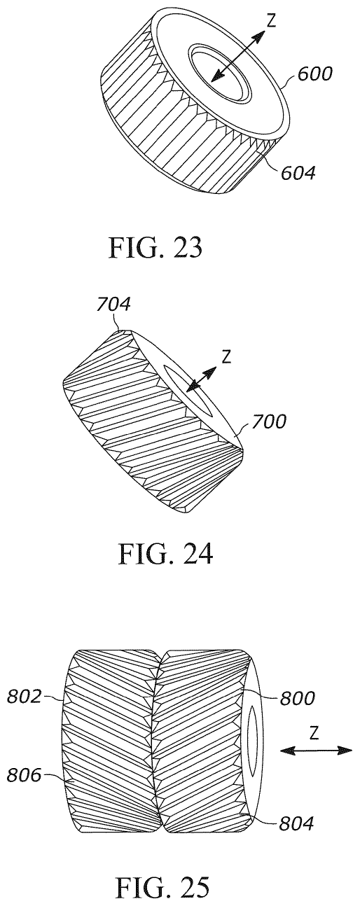

The method 600 further includes forming, cutting, knurling, and/or hobbing a plurality of indentations in the plurality of pips. The indentations may be disposed at an angle of 5 degrees up to about 90 degrees, 10 degrees and about 80 degrees, between about 20 degrees and about 70 degrees, between about 30 degrees and about 60 degrees, between about 40 degrees and about 80 degrees, or in some aspects, between about 40 degrees and about 60 degrees relative to the extrusion direction. In some approaches, the indentations may be formed via a knurling process, for example, using one or more cutting knurls. FIGS. 23-25 illustrate exemplary cutting knurls that may be employed to form the indentations on the metal extrusion. In some approaches, the cutting knurls may be positioned adjacent to each other in the knurling operation. In some approaches, the cutting knurls may be positioned in series. Any suitable configuration of cutting knurls may be utilized to form one or more of the patterns of indentations described herein.

In some approaches, rather than extruding the component of a climbing product, the method 600 may alternatively include die casting the component. The indentation may then be formed, cut, knurled, and/or hobbed in the die cast component rather than in a metal extrusion.

In one approach, to form a cross-hatching pattern, such as the cross-hatching pattern of indentations (such as patterns shown in FIG. 3-4, 10, or 16-17) in the metal extrusion, the metal extrusion may be run through a knurler having one cutting knurl with a plurality of diagonal cutting edges on an outer surface thereof (see e.g., FIG. 24). The metal extrusion may be run through twice in different directions, to form the cross-hatching pattern.

In another approach, to form a chevron pattern (such as the chevron patterns shown in FIGS. 11A, 11B, 12, and 13) in the metal extrusion, the metal extrusion may be run through a knurler having two adjacent cutting knurls, the two cutting knurls having diagonal cutting edges on an outer surface thereof (see e.g., FIG. 25).

In some approaches, the method 606 also includes cutting the metal extrusion to a particular length. A cutting device may cut the metal extrusion to form a rung, a step, a plank, a platform, or any other component of a climbing product. Any suitable cutting device may be employed to cut the metal extrusion to length.

FIG. 23 illustrates an exemplary cutting knurl 700 that may be used to form indentations in a metal surface, in particular, in the pips or ridges on the metal surface. The. The cutting knurl may form a pattern of indentations in the pips or ridges. The cutting knurl 700 is a wheel that includes a plurality of edges 704 on its outer surface. The plurality of edges 704 may penetrate the pips or ridges to form the pattern of indentations therein. The edges 704 of the cutting knurl 700 are parallel to an axis of rotation Z of the cutting knurl. In some approaches, the axis of rotation Z of the cutting knurl is oriented perpendicular to the extrusion direction of the rung, plank, or other surface. In this manner, the cutting knurl 700 forms indentations that are perpendicular to the extrusion direction. In some approaches, the axis of rotation Z of the cutting knurl 700 may be at an angle relative to the extrusion direction of the rung. In this manner, the cutting knurl 700 may form the indentations at an angle relative to the extrusion direction. In some approaches, the cutting knurl may be made of a steel material.

FIG. 24 illustrates another exemplary cutting knurl 80 that may be used to form a plurality of indentations in a metal surface, in particular, in the pips or ridges on the metal surface. The cutting knurl 800 may form a pattern of indentations in the pips or ridges. The cutting knurl 800 is a wheel that includes a plurality of edges 804 on its outer surface. The plurality of edges 804 may penetrate the pips or ridges to form the pattern of indentations therein. The edges 804 of the cutting knurl 800 are at an angle relative to an axis of rotation Z of the cutting knurl 800. In some approaches, the axis of rotation Z of the cutting knurl 800 may be oriented perpendicular to the extrusion direction for the rung. In this manner, the cutting knurl 800 may form the indentations at an angle relative to the extrusion direction.

FIG. 25 illustrates a pair of cutting knurls that may be employed to form indentations in a metal extrusion, for example in pips and/or ridges present on the metal extrusion. The pair of cutting knurls includes a first cutting knurl 800 and a second cutting knurl 802. The first cutting knurl 800 includes a first plurality of edges 804 oriented diagonally along the outer surface of the first cutting knurl 800 with reference to the axis of rotation Z. The second cutting knurl 802 includes a second plurality of edges 806 oriented diagonally along the outer surface of the second cutting knurl 802 with reference to the axis of rotation Z. The first plurality of edges 804 and the second plurality of edges 806 are sloped towards each other such that the first plurality of edges 804 and the second plurality of edges 806 form a chevron pattern on the outer surface of the first cutting knurl 800 and the second cutting knurl 802 when the first cutting knurl 800 is positioned adjacent the second cutting knurl 802.

In one example, the pair of cutting knurls may be used to form the chevron-type pattern illustrated on the plank illustrated in FIGS. 12-14.

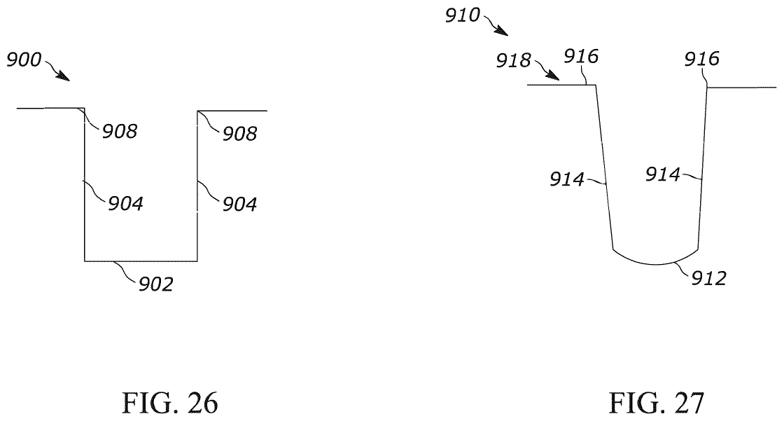

FIG. 26 illustrates an alternative cross-sectional shape for the indentations described herein, in accordance with some embodiments. The indentation 900 has a rectangular cross-sectional shape formed by sidewalls 904 and a lower surface 902 that is generally flat. The lower surface 902 may provide an engagement surface that engages with a portion of the user to further improve slip-resistance or grip. In some approaches, the sidewalls 904 may be approximately perpendicular with respect to the lower surface 902. In other approaches, the sidewalls 904 may be sloped relative to the lower surface 902. The sidewalls 904 also form two edges 908 (which appear as points in FIG. 26). The sidewalls 904 also provide further engagement surfaces that may further help to improve slip-resistance or grip.

FIG. 27 illustrates another alternative cross-sectional shape for the indentations described herein. The indentation 910 is generally “U”-shaped in cross-section. The indentation 910 includes sidewalls 914 and a lower surface 912. The lower surface 912 that is generally curved or arcuate. In some approaches, the sidewalls 914 may be sloped towards each other. The sidewalls 914 may also be generally perpendicular to an upper surface 918 of the pip or the ridge in which the indentation is formed. In some aspects, may be at an angle of between about 10 degrees to about 80 degrees, between about 30 degrees to about 70 degrees, between about 40 to about 60 degrees, between about 5 and about 45 degrees, between about 10 and about 40 degrees, or between about 40 and about 80 degrees relative to the upper surface 918 of the pip or the ridge. The sidewalls 914 also form two edges 916 (which appear as points as shown in FIG. 27) and may also provide further engagement surfaces to improve slip-resistance or grip.

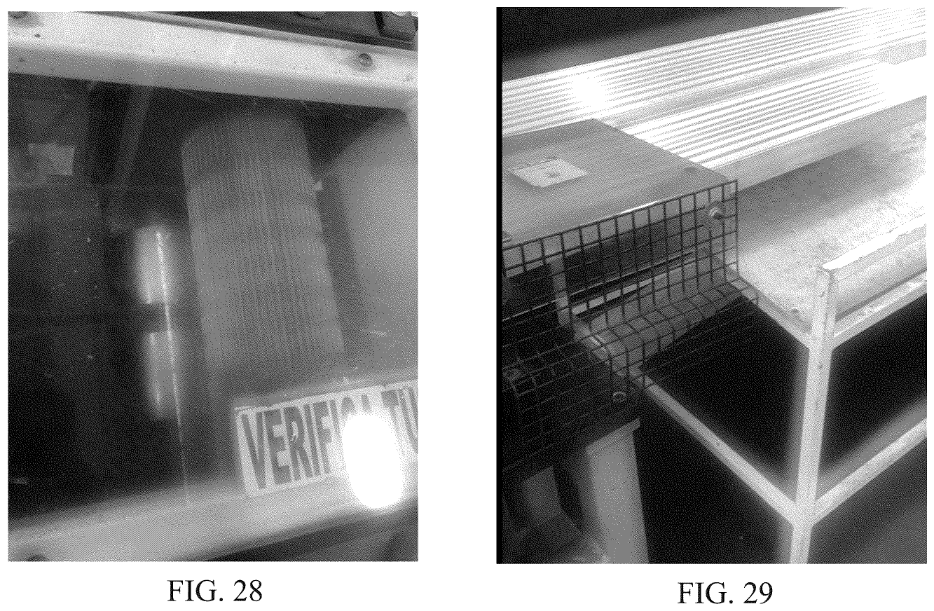

FIG. 28 illustrates another exemplary cutting knurl that may be used to form the indentations described herein in accordance with some embodiments. In some approaches, the exemplary cutting knurl may be used to form a plurality of indentations across an entire width of a plank, for example, for a work platform. It is to be understood that the size (e.g., width) of the cutting knurls described herein may be adjusted based on the desired dimensions of the pattern formed in the metal extrusion or other tread member.

FIG. 29 illustrates an exemplary knurler that may be used to form the indentations described herein in accordance with some embodiments.

It is contemplated that the patterns for the slip-resistant treads from any embodiment described herein may be applied to any of the metal extrusions (e.g., rungs, steps, planks, platforms) described herein or portions thereof.

The climbing products, components, and/or accessories described herein may be formed of a variety of materials and using a variety of manufacturing techniques. Such materials may include, e.g., metals, plastics and other polymers, and/or composite materials. In addition, some portions of the climbing product's components may be formed of one material and one or more other components or accessories may be formed of another similar, or entirely distinct material. In some configurations, the rails of the climbing products may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as steel, aluminum, or aluminum alloys and manufactured via an extrusion process. After extrusion or pultrusion, the rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The tread members (e.g., steps, rungs, planks, platforms) of the climbing products may be attached to the rails in a variety of different manners. In one approach, the climbing members and rails are forged together, such as by having the tread members being attached to the rails via a direct swage connection. In a direct swage connection, a tread member is attached directly to the rails using a cold forming process, where a moving die shapes the tread member around a hole that was pre-punched in the rail. Annealing operations may be used to soften the metal to prevent cracking. In other approaches, the tread members are attached to the rails via a plate connection in addition to other attachment types. In a plate connection, a tread member is attached to a plate and the plate is attached to the rail via one or more rivets or other mechanical elements.

Other accessories and assemblies employed in the climbing product, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the climbing product. Metal locks may be extruded and then indentation to length. Rope pulleys may include extruded metal side portions and plastic round pulleys formed of injection molded plastic, with the side portions and pulley held together by a rivet. End caps may be riveted or snap fit to the climbing product during assembly. Similarly, knee caps may be riveted to the climbing product.

In some approaches, a climbing product comprises a first rail. The climbing product comprises a second rail in parallel and spaced relation with the first rail. The climbing product comprises a metal extrusion having a standing surface attached to the first rail and the second rail upon which a user stands. The standing surface may have pips which provide slip resistance and traction for the user perpendicular to the extrusion direction and indentations which provide slip resistance and traction for the user in parallel to the extruded direction.

The indentations may be at an angle of at least 10 degrees relative to the extrusion direction of the standing surface. The indentations may form a pattern on the standing surface. The indentations may form a repeating pattern on the standing surface. The indentations may be segments. The indentations may form a repeating pattern of indentations which are perpendicular to the direction of the extrusion.

In some approaches, the slip-resistant treads described herein may add slip resistance in the extrusion direction of the standing surfaces of a climbing product. The slip-resistant treads may comprise a pattern of indentations in the extruded aluminum standing surfaces of climbing products. The extrusion may be made of other metals and even plastics. The indentations may be produced by rolling or cutting or other methods. The purpose of these indentations may be to increase user traction in the extruded direction of a standing surface.

In some approaches, the indentations described herein could be applied to ladder steps, ladder rungs, the standing surfaces of planks, and to any standing surface which is made from extrusions. The indentations may be an angle of at least 10 degrees and up to 90 degrees relative to the extrusion direction of the standing surface. The depth of the indentations may be at least 0.010 inches deep into the standing surface and up to penetrating entirely through the extrusion (or through a pip formed thereon) from the standing surface. The indentations may penetrate the pips of the standing surface. The indentations may be at least 0.010 inches wide and at least 0.010 inches long. The indentations may be of an overall size which effectively does not decrease the strength or integrity of the extrusion to be able to withstand typical loads of at least 300 lbs. of a user standing on the standing surface of the extrusion. The indentations may form a pattern of segments extending linearly across the width of the standing surface of the extrusion at a desired length and width and depth. The indentations may serve as treads against which the bottom of a shoe may press when there is lateral force applied to the shoe in the extrusion direction to catch the shoe and serve as slip resistance and traction for the shoe.

In some approaches, a climbing product for a user comprising: a first rail; a second rail in parallel and spaced relation with the first rail; and a metal extrusion having a standing surface attached to the first rail and the second rail upon which a user stands, the standing surface having pips which provide slip resistance and traction for the user perpendicular to the extrusion direction and indentations which provide slip resistance and traction for the user in parallel to the extruded direction.

The climbing product may have indentations at an angle of at least 10 degrees relative to the extrusion direction of the standing surface. The indentations may also form a pattern on the standing surface, such as a repeating pattern, for example a diagonal pattern. The indentations may also be segments.

In some approaches, A method for making a climbing product comprising creating indentations in a standing surface of an extrusion of the climbing product which form an angle of at least 10 degrees with an extrusion direction of the extrusion; and permanently fixing the standing surface to rails of the climbing product.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A climbing product comprising:
a first rail;
a second rail in parallel and spaced relation with the first rail; and
a metal extrusion coupled to the first rail and the second rail, the metal extrusion including surface having a plurality of pips extending in an extrusion direction of the metal extrusion, the plurality of pips having a first plurality of indentations formed therein, the first plurality of indentations disposed at an angle of between about 5 degrees and about 85 degrees relative to the extrusion direction.

2. The climbing product of claim 1, wherein the plurality of pips are protrusions that extend upward from a plane forming a body of the metal extrusion.

3. The climbing product of claim 1, wherein the first plurality of indentations.

4. The climbing product of claim 1, wherein the first plurality of indentations form a pattern on the surface.

5. The climbing product of claim 4, wherein the pattern is a repeating pattern.

6. The climbing product of claim 4, wherein the pattern is at least one of a chevron pattern or a cross-hatching pattern.

7. The climbing product of claim 1, wherein the first plurality of indentations have a cross-section that is at least one of “V”-shaped, “U”-shaped, or rectangular.

8. The climbing product of claim 1, wherein the first plurality of indentations are formed by cutting the plurality of pips using a cutting knurl.

9. The climbing product of claim 1, wherein the plurality of pips further includes a second plurality of indentations oriented perpendicular to the extrusion direction.

10. The climbing product of claim 1, wherein the first plurality of indentations includes a first group of indentations at a first angle relative to the extrusion direction and a second group of indentations at a second angle relative to the extrusion direction, the first angle being different from the second angle.

11. A tread member for a climbing product, the tread member having surface including a tread, the tread comprising:
a plurality of pips extending in first direction of the surface; and
a first plurality of indentations formed in the plurality of pips at an angle of between about 5 degrees and about 85 degrees relative to the first direction.

12. The climbing product of claim 11, wherein the surface is part of a metal extrusion, and wherein the first direction is an extrusion direction for the metal extrusion.

13. The climbing product of claim 11, wherein the surface is part of at least one of a rung, a step, a plank, or a platform.

14. The climbing product of claim 11, wherein the first plurality of indentations includes a first group of indentations at a first angle relative to the first direction and a second group of indentations at a second angle relative to the first direction, the first angle being different from the second angle.

15. The climbing product of claim 11, wherein the plurality of pips are formed in discrete groups of pips.

16. The climbing product of claim 15, wherein the discrete groups of pips include between about 2 and about 15 pips.

17. The climbing product of claim 11, wherein at least some pips in the plurality of pips have a pointed apex extending upward from the surface.

18. A method of making a metal extrusion having a slip-resistant tread, the method comprising:
extruding a metal in an extrusion direction to form a metal extrusion having at least one planar surface, the metal extrusion including a plurality of pips that extend along the at least one planar surface in the extrusion direction and protrude upward from the at least one planar surface; and
forming a plurality of indentations in the plurality of pips, the plurality of indentations disposed at an angle of about 5 degrees up to about 85 degrees relative to the extrusion direction.

19. The method of claim 18 wherein forming a plurality of indentations in the plurality of pips includes cutting the plurality of pips with a knurling wheel.

20. The method of claim 18, wherein the method further includes cutting the metal extrusion to a particular length to form at least one of a rung, a step, a plank, or a platform.
